(19) United States
(12) Patent Application Publication
(10) Pub. No.: US 2014/0260884 A1
(43) Pub. Date: Sep. 18, 2014

(54) SUBSTRATE PROCESSING METHOD

(71) Applicant: LIEN DING SYSTEMS CO., LTD., Guishan Township (TW)

(72) Inventor: Ha-Dih HSIEH, Zhubei City (TW)

(73) Assignee: LIEN DING SYSTEMS CO., LTD., Guishan Township (TW)

(21) Appl. No.: 13/829,760

(22) Filed: Mar. 14, 2013

(51) Int. Cl. B26D 3/06

(52) U.S. Cl. CPC B26D 3/065
USPC 83/875

(57) ABSTRACT

A substrate processing method includes following steps. Multiple sawing blades are applied to a substrate for forming multiple side-by-side grooves. Each groove includes a short edge, and opposite a first long edge and a second long edge. A milling blade is used for milling one of the grooves. During the milling process the milling blade starts at a feed point and moves along a first feed path head toward the short edge, away from the groove, and intersects with the first long edge of the groove. The milling blade then proceeds to a second feed path, followed by moving to the third feed path, and eventually stops at an end point. The third feed path leads the milling blade toward the groove, away from the short edge of the groove, and then intersects with a second long edge of the groove before it eventually stops at the end point.

### BACKGROUND

1. Technical Field

The invention relates to a substrate processing method, and more specifically, to a processing method for substrates containing grooves.

2. Background

Heretofore, light emitting diodes (LEDs) are usually mounted on an aluminum substrate with good thermal conductivity that serves as a heat sink to dissipate heat induced by the LED during operation.

The general concept for the production of LED lighting devices is to attach the LED to an aluminum substrate whose surface is covered with pre-formed circuit layouts. As an example, consider a Liquid-crystal display television (LCD TV) employing the LEDs. In this example, multiple LED units are mounted on a long strip of aluminum substrate to form an ultra-thin TV display screen. The usual method used for producing the strips of aluminum substrate is to form several photolithography circuit layouts on a flat aluminum substrate plate (for instance, a rectangular plate of 600 mm*480 mm), followed by forming multiple grooves adjacent to each other in parallel on the aluminum substrate plate without causing damage to the circuit layouts. These grooves cut to the back surface of the aluminum plate without separating individual substrate strip from the aluminum plate, and all substrate strips remain attached at both ends. Next, multiple units of LED are die-bonded to each strip of substrate and finally adjacent LED substrates are severed off at both ends and separated.

There are two approaches for creating multiple adjacent grooves on an aluminum substrate plate in parallel: the first is die stamping, which casts grooves on the aluminum substrate, and the second is mill cutting, which applies milling blades on the aluminum substrate.

The die stamping approach may leave burrs along the edges of the cuts and cause deformation to the substrate plate, limiting further processing afterward. As a result, die stamping may lead to products of less satisfactory quality and may result in yield loss. The die sampling method requires different mold tools for producing different sizes of groove, resulting in a longer preparation cycle and increased costs. There are also limits in the size and ratio of dimensions of groove that the die stamping method can perform. To produce a long groove, it may take multiple molds to complete the die stamping process. Moreover, in some cases, the aluminum substrate of LED-based lighting devices is covered with a layer of ceramic material. Due to its brittle character, the ceramic layer on the surface of an aluminum substrate makes the die stamping method unsuitable. Furthermore, in the case of substrates made of aluminum alloy, the extreme hardness of the aluminum alloy makes the die stamping impossible to perform. The complexity of the production process and the reasons outlined above render the die stamping approach less advantageous for making large-sized devices, particularly in the case of display monitors and fluorescent lighting devices.

On the other hand, the method of using cutting with milling blades to groove the aluminum substrate improves product quality and does not limit the processing of long grooves from which the die stamping method suffers. Previously developed mill cutting methods use a single cutter, and to form ten grooves the cutter includes repeating the same process ten times. The longer processing time of a single blade system results low productivity and makes the cutting method less competitive for mass production.

### SUMMARY

In view of the problems of current methods of substrate processing discussed above, the invention provides a substrate cutting method for improved efficiency for substrate processing.

In some embodiments, the substrate cutting method includes following steps. A cutting machine with multiple sawing blades are arranged in parallel is provided. Multiple grooves in parallel on a substrate plate are formed by the sawing blades of the cutting machine. Each groove includes a first long edge, a second long edge opposite to the first long edge and a short edge located at ends of both the first and second long edges. A milling blade of a milling machine is used to mill one of the grooves by starting at a feed point at a distance from the short edge of the groove. The milling blade moves along the first feed path toward the short edge of the groove, away from the groove itself and intersects with the first long edge of the groove. The milling blade proceeds along a second feed path following the first feed path, and continues to the third feed path away from the short edge of the groove, toward the groove itself, and intersecting with the second long edge of the groove before the blade stops at an end point and a distance from the short edge of the groove, thus removing a portion of the substrate material of the short edge.

In some embodiments, the substrate processing method comprises following steps. A substrate with at least one groove, having a first long edge, a second long edge and a short edge located at the end of both the first and second long edges is provided. A milling blade is used to mill one of the grooves by milling from a feed point at a distance from the short edge of the groove, moving along the first given feed path toward the short edge of the groove, away from the groove itself and intersecting with the first long edge of the groove. Then, the blade is moved along the second feed path following the first feed path. Then, the blade is moved along the third feed path away from the short edge of the groove and toward the groove itself, and intersecting with the second long edge of the groove before stopping at an end point and a distance from the short side of the groove. Accordingly, a portion of the substrate material of the short edge of the groove is removed.

In some embodiments, the substrate processing method comprises following steps. A substrate with at least one groove, having a first long edge, a second long edge and a short edge located at the end of both the first and second long edges is provided. A milling blade is used to mill one of the grooves by milling from a feed point at a distance from the short edge of the groove, moving along the first given feed path toward the short edge of the groove, away from the groove itself and intersecting with the first long edge of the groove. Then, the blade is moved along the second feed path following the first feed path. Then, the blade is moved along the third feed path away from the short edge of the groove and toward the groove itself, and intersecting with the second long edge of the groove before stopping at an end point and a distance from the short side of the groove. Accordingly, a portion of the substrate material of the short edge of the groove is removed.

In the substrate processing method of some embodiments described above, a set of sawing blades is arranged side by side to produce multiple lines of groove in parallel during a single step, thus reducing processing time.

Giving the setting to include a first feed path intersecting with a first long edge of the groove, moving toward the short edge of the groove, away from the groove itself, followed by a third feed path heading toward the groove itself and away from the short edge, and intersecting with a second long edge of the groove, the short edge of the groove is cleanly processed and includes smooth surface joints to a first long edge and a second long edge of the groove for further processing afterward.

The features, implementation and advantages of the invention include been manifested in the context of the state of the art, along with the accompanying drawings in which the structure of the invention is shown by examples.

The following descriptions are exemplary embodiments only, and are not intended to limit the scope, applicability or configuration of the invention in any way. Rather, the following descriptions provide convenient illustrative examples for implementing the invention. Various changes to the described embodiments may be made in the function and arrangement of the elements described without departing from the scope of the invention as set forth in the claims herein.

### DRAWINGS

The present disclosure will become more fully understood from the detailed description given herein below for illustration only, and thus are not limitative of the present disclosure, and wherein:

FIG. 1 is a flow chart of a method for processing a LED substrate in accordance with an embodiment;

FIG. 2A is an embodiment of the composite layout of a processing machine;

FIG. 2B is a side view showing an embodiment of the composite layout of a processing machine;

FIG. 2C is an embodiment of a portion of a processing machine;

FIG. 3 shows grooves at the top of a substrate plate produced by sawing blades in accordance with an embodiment;

FIG. 4 shows grooves in a top of a substrate plate produced by sawing blades in accordance with another embodiment;

FIG. 5A shows grooves in a top of a substrate plate produced by sawing blades in accordance with yet another embodiment;

FIG. 5B shows the processed substrate in the embodiment described in FIG. 5;

FIG. 6A is a partial structural diagram of a groove of an embodiment;

FIG. 6B is a sectional view of a groove taken along the line 6B in FIG. 6A;

FIG. 7 presents a cutaway view of a substrate of another embodiment;

FIG. 8 is an enlarged schematic view of a feed path of the blade in an embodiment;

FIG. 9 is an enlarged schematic view of a groove after the milling process in an embodiment;

FIG. 10 shows a schematic view of a feed path of the milling blade in another embodiment;

### DETAILED DESCRIPTION

With reference to FIGS. 1, 2A, 2B, 2C and 3, the scheme and implementation of the substrate processing method are presented herein. FIG. 1 is a flow chart of a method for processing substrates in accordance with an embodiment. FIG. 2A shows an embodiment of the composite layout of a processing machine FIG. 2B is a side view showing the composite layout of the processing machine. FIG. 2C is a partial structural view of the processing machine. FIG. 3 shows grooves at the top of a substrate plate produced by sawing blades in accordance with the embodiment.

FIGS. 2A to 2C illustrate a composite processing machine 10 that includes a sawing device 100 and a milling device 200. The sawing device 100 includes multiple sawing blades 110 and the milling device 200 includes a mill blade 210 (S1).

Specifically, the composite processing machine 10 includes a machine base 11 on which the sawing device 100 and the milling device 200 are disposed. The sawing device 100 and the milling device 200 are on the machine base 11 in the embodiment, while both can be on two separate machine bases in other embodiments.

The machine base 11 includes a table top 16 where a substrate plate is placed. The composite processing machine 10 further includes an X-axis guide rail 14, a Z-axis guide rail 12 and the Y-axis guide rail 15 stored on the machine base 11.

The sawing device 100 and the milling device 200 are attached to the X-axis guide rail 14 and Z-axial guide rail 12, above against the table top 16, and are powered by, for instance, a linear motor to move along the directions of the X-axis guide rail 14 or Z-axial guide rail relative to the table top 16. Table top 16 is mounted on the Y-axial guide rail 15 and is powered by, for example, a linear motor to travel in the direction of the Y-axial guide rail 15 relative to the machine base 11.

The sawing device 100 includes five sawing blades 110 disposed in parallel, attached to and arranged coaxially with a shift 150. The number of blades specified in the embodiment can vary, without departing from the scope of the invention, depending on the circumstances and the needs of the users.

Next, FIG. 6A is a partial structural diagram of a groove of an embodiment. Refer to FIGS. 3 and 6A, the sawing device 100 is applied on the substrate plate 30 to form multiple grooves 300 side by side, corresponding to the sawing blades 110. Each groove 300 comprises a first long edge 301, a second long edge 302, and a short edge 303 (S2) located at one end of both edges of 301 and 302. (S2).

In this embodiment, the substrate plate 30 is a circuit board substrate, and more specifically but not limited to, a LED aluminum substrate. Having multiple sawing blades 110 used in parallel, the sawing device 100 can produce multiple lines of groove in parallel in a single step, thus reducing processing time.

Even though the diameters of the sawing blades 110 of the embodiment are identical, dimensions of a set of sawing blades may be different, without departing from the scope of the invention. For example, FIG. 4 illustrates a set of sawing blades 110 comprising a group of first blades 111 and a second blade 112, attached to and arranged coaxially with a shift 150. The second blade 112 of a larger diameter than those of first blades 111 is adjacent to first blades 111. The grooves 300 include a long groove 320 and a plurality of short grooves 310 adjacent to the long groove 320. The short grooves 310 are produced by the first blades 111 cutting through the substrate plate 30 and the long groove 320 is produced by the second blade 112 cutting through the substrate plate 30.

In FIG. 5A illustrating another embodiment, a set of sawing blades 110 comprising several first blades 111 and two second blades 112, are attached parallel to and arranged coaxially with a shift 150. All first blades 111 are installed between two second blades 112 of a larger diameter than those of first blades 111.

The grooves 300 include two long grooves 320 and multiple short grooves 310 adjacent to and sandwiched by the two long grooves 320 on both sides, generated by a set of first blades 111 and two second blades 112 respectively cutting through a substrate plate 30. The substrate plate 30 with a set of short grooves 310 and two long grooves 320 being created, as shown in FIG. 5A, can be further processed, such as, using milling blades or sawing blades to produce two cutting slots 330 in parallel and connecting ends of two separate long grooves 320 of both sides, as presented in FIG. 5B. Thus, a piece of rectangular-shaped substrate 31 containing a set of short grooves 310 and edged by two cutting slots 330 and two long grooves 320, can be separated from a substrate plate 30 and become a unit of a semi-finished panel.

Refer to FIGS. 6A, 6B, 7, 8 and 1. FIG. 6B is a sectional view of a groove taken along the line 6B in FIG. 6A. FIG. 7 is a cutaway view of a substrate of another embodiment; FIG. 8 is an enlarged schematic view of a feed path of the blade in an embodiment. As the plurality of grooves 300 are created in parallel on the substrate plate 30 by a set of sawing blades 110, the short edges 303 at both ends of each groove are un-burnished, but rather have roughness and sharp burrs 304. The curve-shaped sawing blades 110 leaves a trajectory and shaggy burrs 304 at the short edge 303 of a groove 300, as illustrated in FIG. 6B. Given the case that the short edges 303 of grooves 300 may be further modified to be mechanical slots, it is necessary to remove burrs 304 and to smooth irregularities. To gain higher productivity, in some embodiments, a set of sawing blades 110 process two layers of substrate plate 30 and 30′, with one atop the other, simultaneously during actual production, as shown in FIG. 7. Again, because of the curve-shaped sawing blades 110, lengths of the grooves 300 and 300′ formed on substrate plate 30 and the one 30′ below respectively are not equal in the embodiment. Thus, a method for de-burring and polishing surfaces of grooves 300 and 300′ is needed for the substrate processing system.

Thus, once the grooves 300 on a substrate plate 30 are formed by a sawing device 100 of the composite processing machine 10, the grooves 300 are then polished and processed by a milling device 200. To remove the disproportion and roughness, a mill blade 210 of a milling device 200, presented in FIG. 2B, begins at a selected point a, a distance L₄ away from the short edge 303 of the groove, moves along a first feed path D1, away from the groove 300, toward the short edge 303 and intersecting with the first long edge 301(S3). The distance L₄, for example, is, but not limited to 3 cm and various lengths can be used for the distance L₄.

In other words, the feed point a of feeding the milling blade 210 is selected inside the groove 300; the first feed path D1 stretches from the feed point a toward a short edge 303, having a cutting edge angle θ₁ between a cutting direction and a long edge 301 of the groove 300. The next step is to continue to move the milling blade 210 in a second feed path D2 following the first feed path D1. In addition, the second feed path D2, which is a semicircular-shaped path, lays substantially parallel and closely next to the short edge 303 outside the groove 300, as shown in FIG. 8. In addition to being angular, the shapes of a second feed path D2 can be different, such as, polygonal as demonstrated in FIG. 10, or a straight line in some embodiments.

The milling blade 210 is then directed to a third feed path D3, which is extended from the second feed path D2, to remove partial material from the substrate plate 30 at the short edge 303 before it reaches an end point b, wherein the end point b is at the distance L₄ away from the short edge 303 of the groove 300. The third feed path D3 heads toward the groove 300, away from the short edge 303 and intersects with the second long edge 302 (S5). The distance L₄ is, but not limited to, 3 cm and various lengths can be used for the distance L₄. Furthermore, the end point b of falls inside the groove 300 following the feed path D3 that moves away from the short edge 303 and includes the cutting edge angle θ₂ between the cutting direction and the second long edge 302 of the groove 300. Thus, a processing path comprises the first feed path D1, the second feed path D2 and the third feed path D3 forming an angular edge around the short edge 303. The milling blade begins at the feed point a, travels along the first feed path D1, the second feed path D2 and the third feed path D3, and moves toward the end point b, to cleanly and smoothly remove burrs 304 on the short edge 303, as shown in FIG. 9. Giving the setting of the processing path to include an acute angle θ₁ between the first feed path D1 and the first long side 301 plus the acute angle θ₂ between the second feed path D3 and the second long edge 302, the milling blade 210 is able to form a milled edge 305 on the substrate plate 30 by milling along a first feed path D1, a second feed path D2, and a third feed path D3 with smooth connections to both the first long edge 301 and the second long edge 302, as shown in FIG. 9. Such setting can avoid uneven or unsmooth surface near the joints of the milled edge 305 to the first long edge 301 or the milled edge 305 to a second long edge 302 due to precision deviations of milling blade 210 caused by positioning tolerances, making further process easier and subsequently preventing light leakage once LED is mounted. In the preferred embodiment, as described in FIG. 8, the first long edge 301 and the second long edge 302 of the groove 300 are apart by the distance L1, equivalent to a design value or a production target value L±tolerance value t. The distance L2 between the feed point a and the end point b of a processing path is L−t, whereas the distance L3 between an end point c of a first feed path D1 (equivalent to a starting point of a second feed path D2) and a starting point d of a third feed path D3 (the same as an end of a second feed path D2) is L+t. For example, if the distance L1 is 2.0±0.1 cm, then the distance L2 is 1.9 cm and distance L3 2.1 cm. As a result, even disregarding what the tolerance value t of the distance L1 between the first long edge 301 and the second long edge 302 is, the feed point a and end point b definitely reside within the groove 300 as well as the end point c of the first feed path D1 and the starting point of the third feed path D3 outside the groove 300 in the substrate plate 30. Accordingly, in reference to the parameter settings of the distance L2 and the distance L3, once the width (distance L1) of the groove 300 in the substrate plate 30 is within the tolerance margin, the process program is applicable to every substrate plate 30 without further adjustments or modifications. The substrate process method described in the embodiments relies on multiple cutting blades used in parallel to form a set of grooves side by side in one operational step. In addition, by including two acute angles in the process settings, one angle positioned between a first feed path and a first long edge of the groove as well as the other angle between a third feed path and a second long edge of the groove, the milling blades can clean up the short edge of the groove having smooth surface joints to a first long edge and a second long edge of the groove. Subsequently, the outcomes of the embodiments make further process easier afterward and prevent light leakage once LED is mounted.

Using sawing(cutting) and milling blades to process substrate plates as described in the embodiments, can overcome process problems that die stamping tools or mold tools currently include to face, thus increasing production yield rate and efficiency, and can operate without restrictions on groove dimensions and substrate materials and consequently, reduce wasted material.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A substrate processing method, comprising following steps:
using sawing blades of a processing machine which are installed in parallel for forming multiple grooves side by side on a substrate plate with each groove including a first long edge, a second long edge and a short edge located at ends of both the first and second long edges;
operating a milling blade of the processing machine to mill one of the grooves, wherein the milling blade begins from a feed point at a distance away from the short edge of the groove, moves along a first feed path toward the short edge of the groove, away from the groove itself and intersecting with the first long edge of the groove;
moving the milling blade along a second feed path following the first feed path; and
operating the milling blade along a third feed path in opposite direction to the short edge, toward the groove, and intersecting with the second long edge of the groove before that the blade stops at an end point a distance from the short edge of the groove, thus removing a portion of the substrate of the short edge.

2. The substrate processing method according to claim 1, wherein the feed point and the end point are located inside the groove and the second feed path is outside the groove.

3. The substrate processing method according to claim 2, wherein an acute angle is between the first feed path and the first long edge of the groove, and another acute angle is between the third feed path and the second long edge.

4. The substrate processing method according to claim 2, wherein the distance between the first long edge and the second long edge is equal to a design value or a production target value L±tolerance value t, the distance between the feed point and the end point is L−t and the distance between an end point of the first feed path and a starting point of the third feed path is L+t.

5. The substrate processing method according to claim 1, wherein of the sawing blades comprises first blades and two second blades arranged side by side, the first blades are installed between the two second blades of a larger diameter than the diameters of the first blades, the grooves include two long grooves and a plurality of short grooves in parallel, the short grooves are generated by the first blades and the long grooves are generated by the second blades.

6. The substrate processing method according to claim 5, wherein of the first blades and the two second blades are attached to and arranged coaxially with a shift.

7. The substrate processing method according to claim 1, wherein of the sawing blades installed in parallel comprises first blades and a second blade adjacent to the first blade, the second blade includes a larger diameter than those of the first blades, the grooves include a long groove and multiple short grooves adjacent to the long groove, the short grooves are generated by the first blades and the long groove is generated by the second blade.

8. The substrate processing method according to claim 7, wherein the first blades and the second blade are attached to and arranged coaxially with a shift.

9. A substrate processing method, comprising following steps:
providing a substrate with a groove, having a first long edge, a second long edge and a short edge located at ends of both the first and second long edges
operating a milling blade for milling the groove, wherein the milling blade begins from a feed point at a distance from the short edge, moves along a first feed path toward the short edge of the groove, away from the groove and intersecting with the first long edge of the groove;
moving the milling blade to a second feed path following the first feed path; and
moving the milling blade along a third feed path in opposite direction to the short edge and toward the groove itself, and intersecting with the second long edge of the groove before stopping at an end point which is at a distance from the short edge, thus removing a portion of the substrate of the short edge of the groove.

10. The substrate processing method according to claim 9, wherein the feed point and end point reside within the groove, and the second feed path is outside the groove.

11. The substrate processing method according to claim 10, wherein an acute angle is between the first feed path and the first long edge of the groove, and another acute angle is between the third feed path and the second long edge of the groove.

12. The substrate processing method according to claim 10, wherein a distance between the first long edge and the second long edge is equal to a design value or a production target value L±tolerance value t, and a distance between the feed point and the end point is L−t and a distance between an end point of the first feed path and a starting point of the third feed path is L+t.
